(19) United States
(12) Patent Application Publication
(10) Pub. No.: US 2023/0274320 A1
(43) Pub. Date: Aug. 31, 2023

(54) Gradar Web, Cloud and AI Based Fundraising Evaluation Auto Pitch Deck Generator and Feedback System

(71) Applicant: Martin Randolph, Marina, CA (US)

(72) Inventor: Martin Randolph, Marina, CA (US)

(21) Appl. No.: 17/683,268

(22) Filed: Feb. 28, 2022

(51) Int. Cl. G06Q 30/02

(52) U.S. Cl. CPC G06Q 30/0279

(57) ABSTRACT

A Web, Cloud and AI based fundraising evaluation and feedback system that links fundraising clients with technical experts and helps to guide new startups and individuals looking to capitalize on their idea or innovation. The fundraising evaluation and feedback system comprise of an interface, a client app or web based terminal to input information about their relevant idea or innovation to get an analysis on the best possible options for raising capital or funds. Additionally, it also provides exclusive market analysis and research on the idea or innovation as to its viability in raising funds. Auto generation of Pitch Deck via data input by users of the platform.

### FIELD OF THE INVENTION

The present invention relates to an evaluation and feedback system for innovative ideas for fundraising activities.

### BACKGROUND OF THE INVENTION

Startups and individuals looking to raise capital via fundraising but need an evaluation or feedback on their specific idea and whether the idea in question is viable. Usually, the current market practice is that the inventors and innovators must do such evaluation and research on their own or hire expensive experts who may or may not be able to help in this evaluation process. The primary market for this invention are startups or individuals who may have a specific innovative idea or invention but need it to be evaluated for its viability.

### SUMMARY OF THE INVENTION

Provided herein is an evaluation and feedback system which incorporates AI and other accessing tools to efficiently and effectively evaluate an innovative idea or invention as well provide a path towards raising capital and connecting with the right people who are able help with this aspect.

The system works in the shape of a web based application or mobile app based software to which users being individuals or startups can sign up to. After signup the AI based software will prompt the user and ask them to fill information related to their specific idea or invention, the target market along with documentation which the user may have prepared beforehand on the platform which can be referred to as a Pitch Deck. There will be an aspect of automatic Pitch Deck generation via the data inputted by users of the platform be it through the App or Web portal. Following which the user will be given feedback on their Pitch Deck in terms of its viability along with what errors have been committed and along with improvements to be made and how they can be done.

After highlighted improvements on the Pitch Deck itself have been made to as point where it is reflective in the Gradar assessment percentage tool. Following which a specific analysis will be issues in relation to the users innovate idea or invention being reflective in the Pitch Deck, if the viability is present the user will be prompted towards a payment terminal to make payment to be connect to expert who can help guide that user towards fundraising. Another specification being that off an automatic Pitch Deck creation or generation in relation to any and all data inputted by the users related to their idea, innovation or invention in question on the aforesaid platform.

The incorporation of an evaluation and feedback system which highlights and guides user to improve their idea or Pitch towards raising funding by the user of AI and other online accessing tools is an new and revolutionary idea which does not exist in the market. The adaption of this system will provide users looking to raise capital better flexibility and give them tools to make sure that they are able to effectively implement their idea or invention.

### BRIEF DESCRIPTION OF THE DRAWINGS

In order that the advantages of the invention will be readily understood, a more detailed description of the invention briefly described above will be rendered by reference to specific embodiments that are illustrated in the appended drawings. Understanding that these drawings depict only typical preferred embodiments of the invention and are not therefore to be considered to be limiting of its scope, the invention will be described and explained with additional specificity and detail through the use of the accompanying drawings, in which:

FIG. 1 illustrates a flow chart outline the general working mechanism of the innovation as outlined.

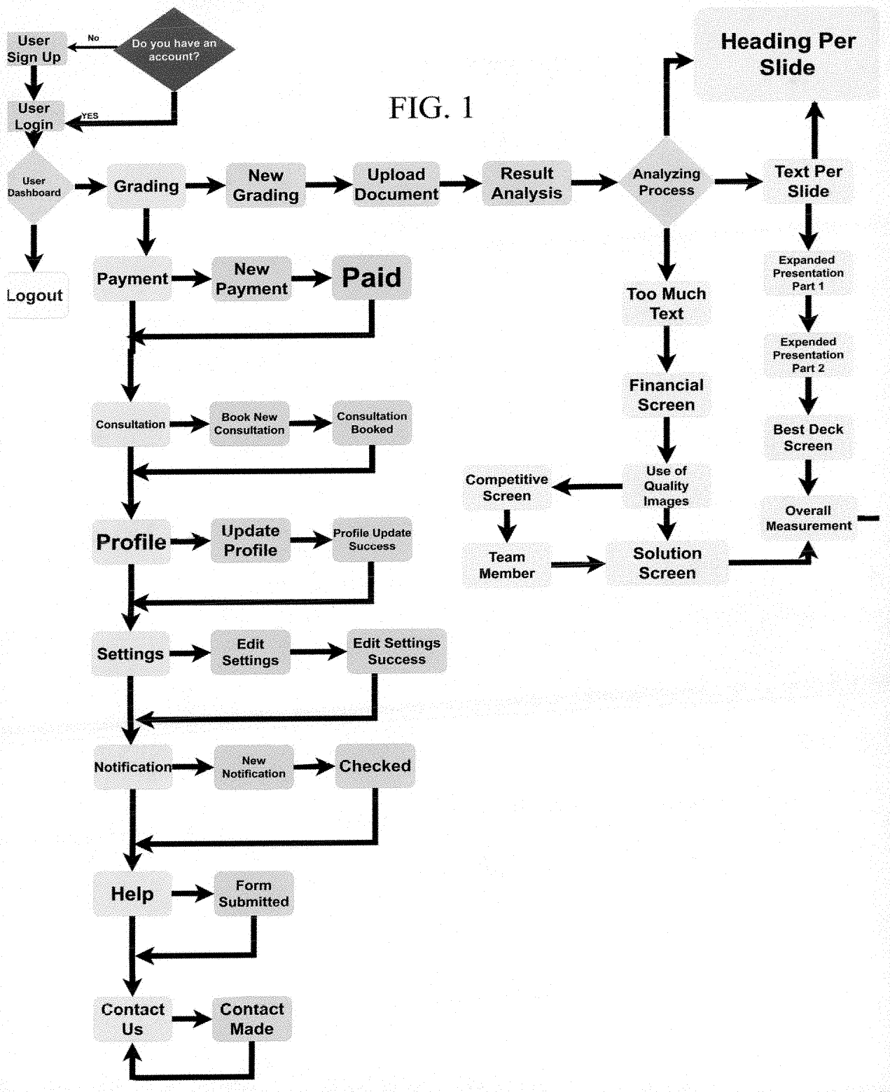

FIG. 2 specifies the aspect of Pitch Deck creation via data input from different stages.

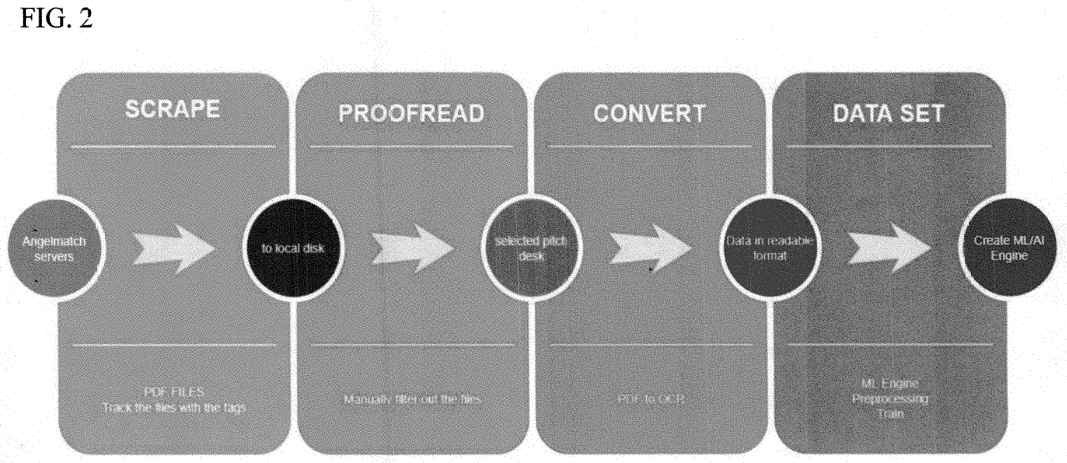

FIG. 3 outlines the Gradar sign user interface.

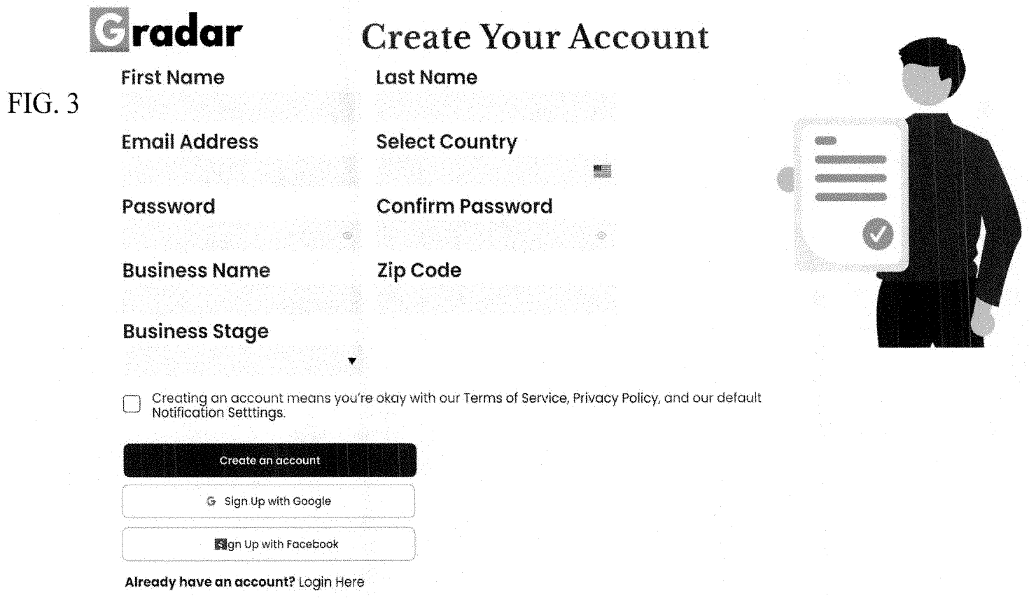

FIG. 4 is another illustration of the gradar user interface for sign up or in.

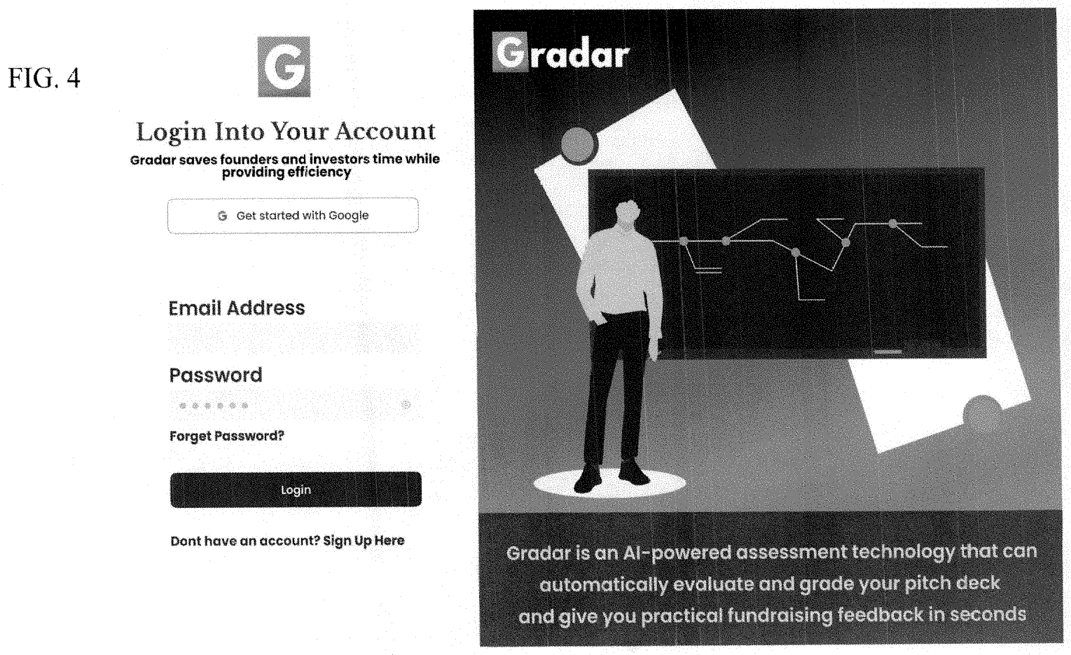

FIG. 5 is the demonstration of the user interface when logged or signed in on Gradar.

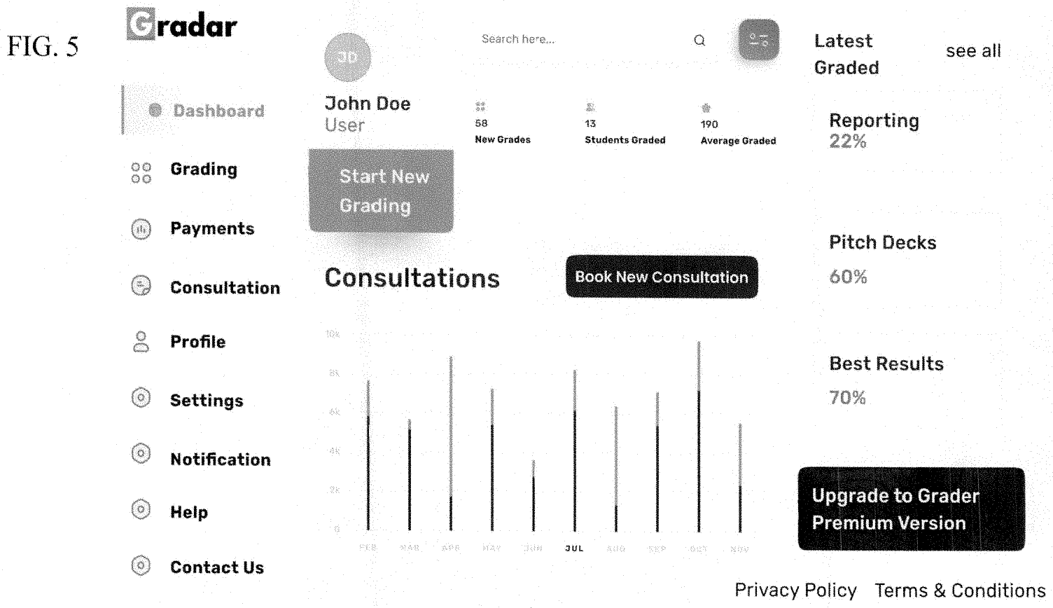

FIG. 6 is the illustration of the user interface when the grading processing is in effect.

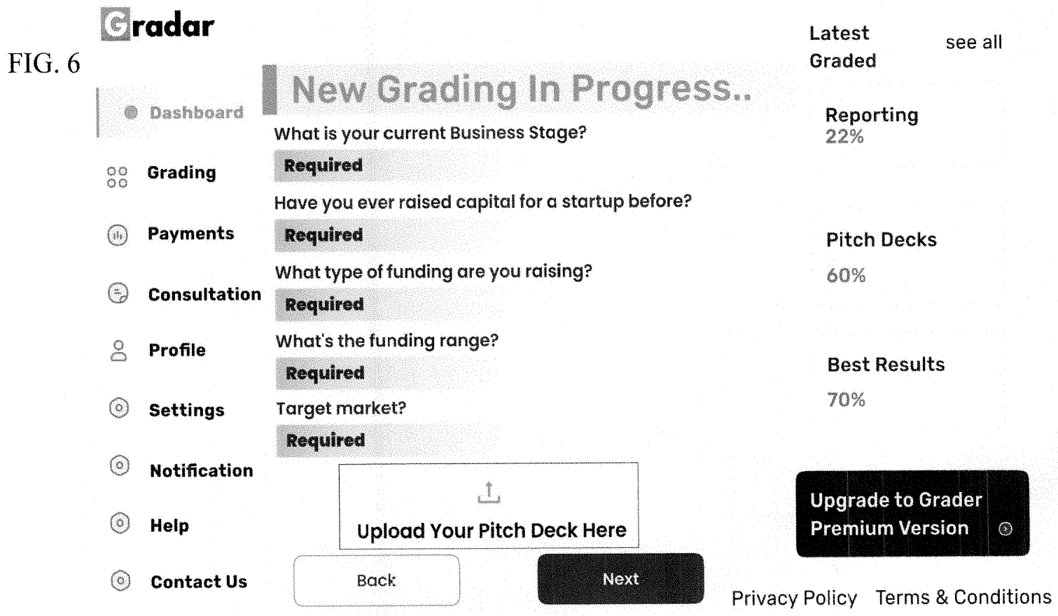

FIG. 7 illustrating the document or data review processing via the Gradar platform.

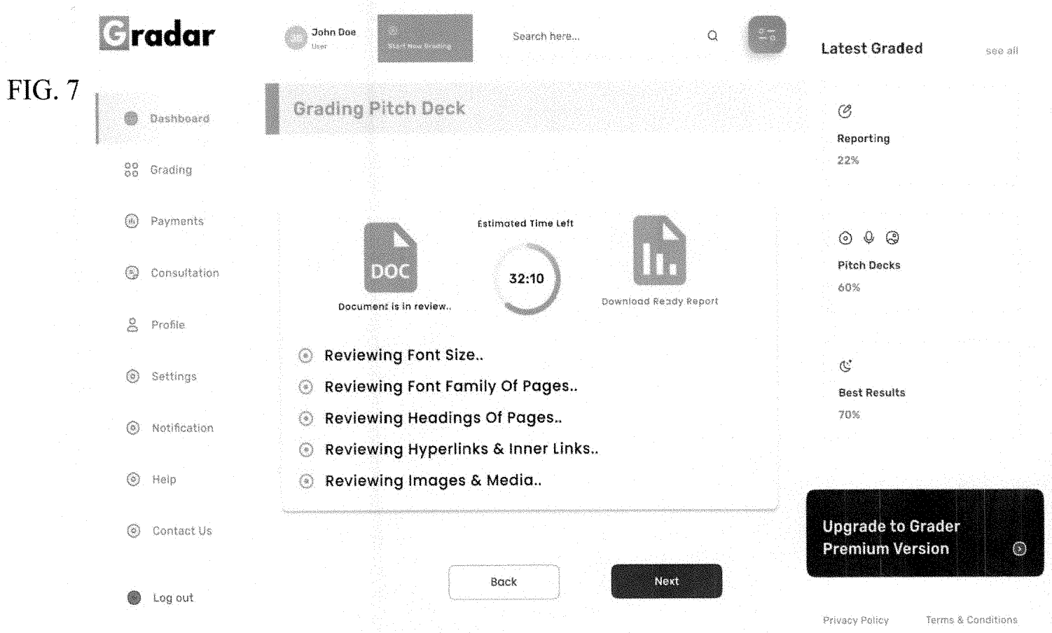

FIG. 8 is the illustration of feedback report or analysis issued by the Gradar system.

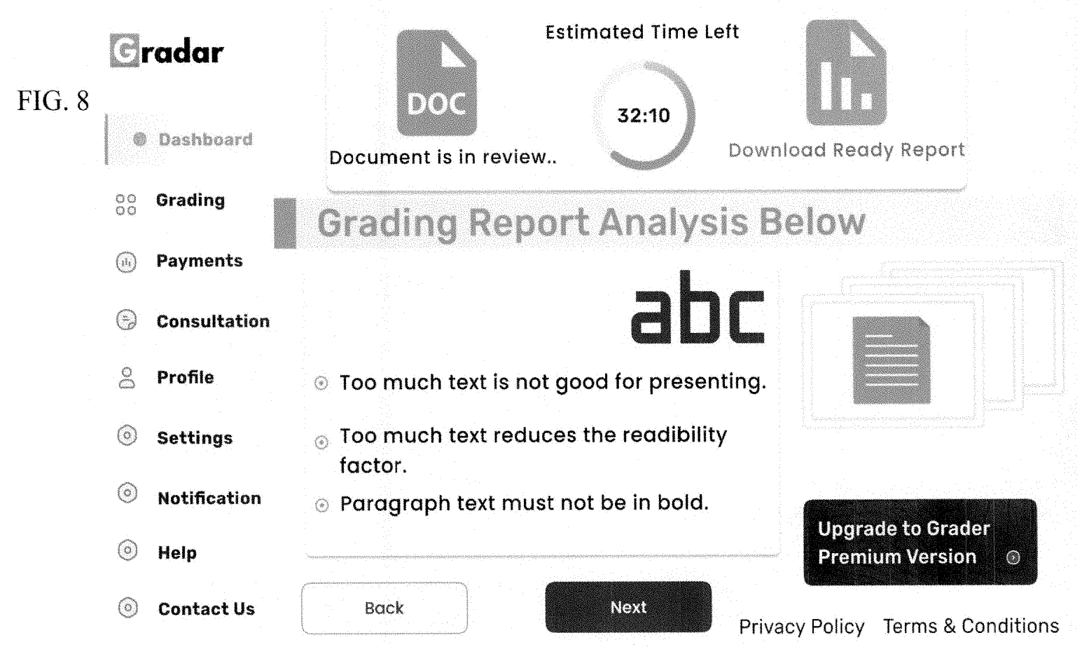

FIG. 9 is another illustration of the feedback report or analysis issued by the Gradar system.

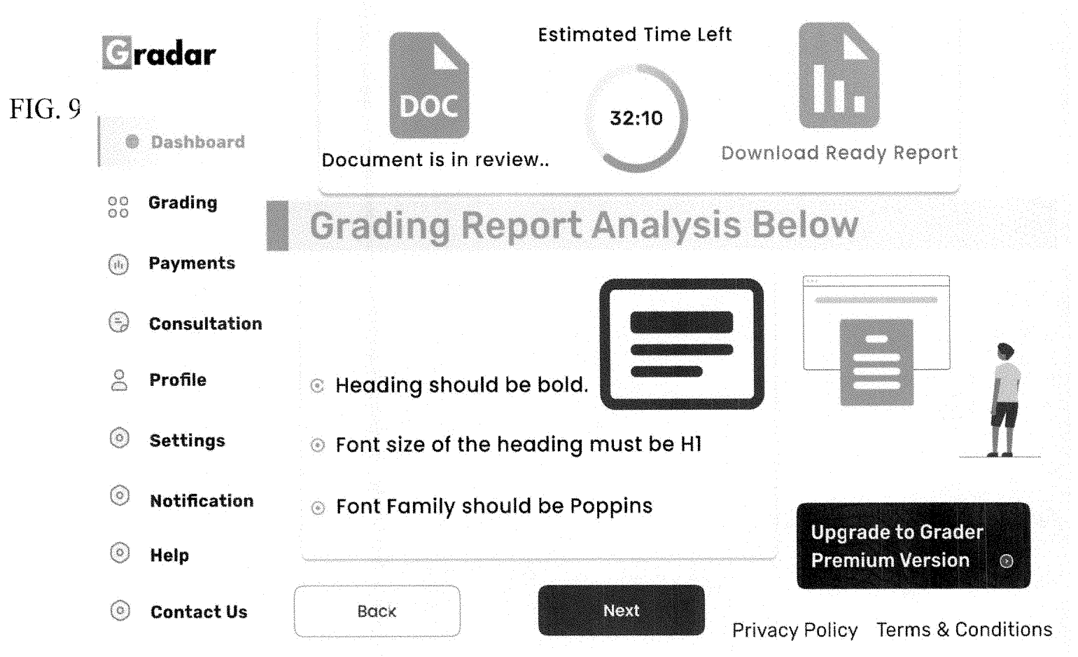

FIG. 10 is also another demonstration of feedback report or analysis issued by the Gradar system

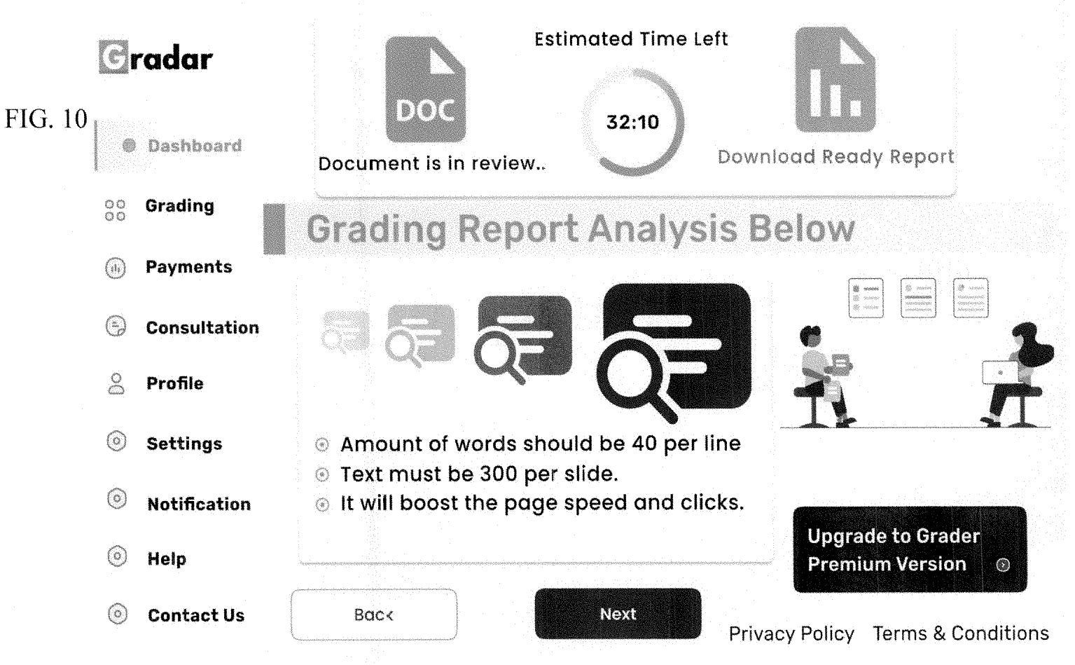

FIG. 11 is an outline of the team of experts of who can be contact by the user after final evaluation of the Gradar system.

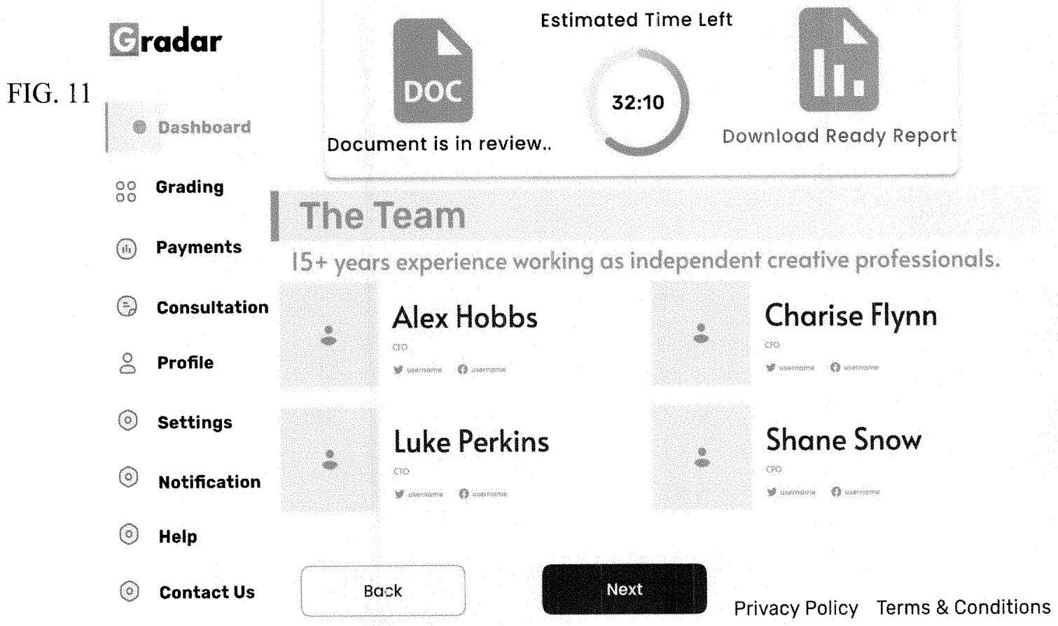

FIG. 12 is an illustration of the business model aspect by the Gradar evaluation system.

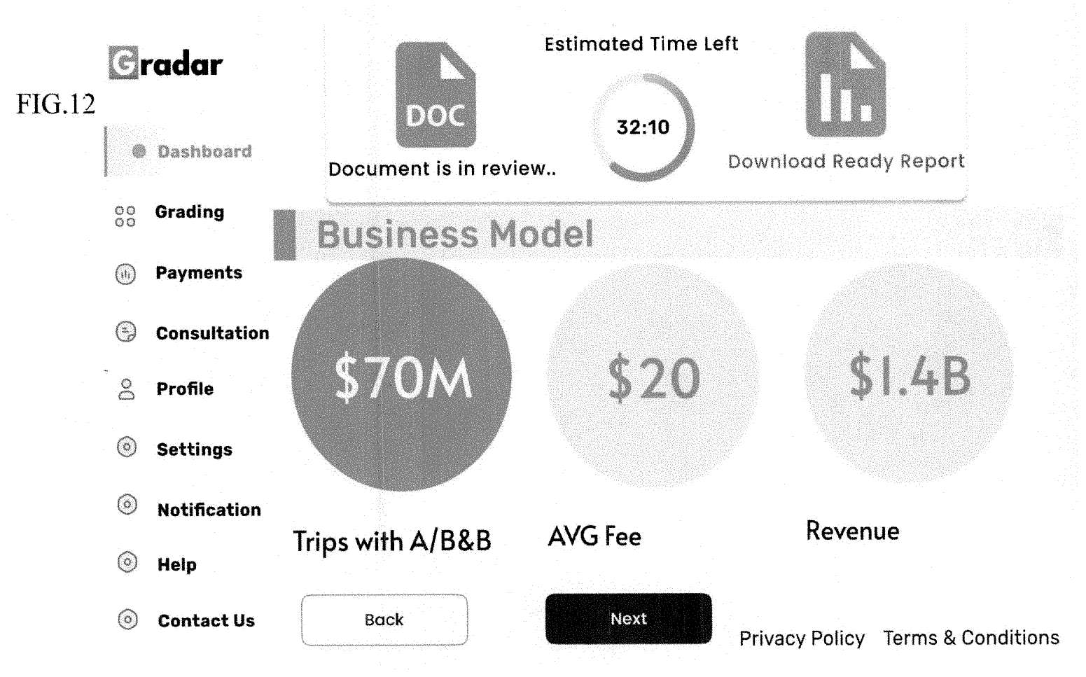

FIG. 13 is another illustration of the Grading report analysis.

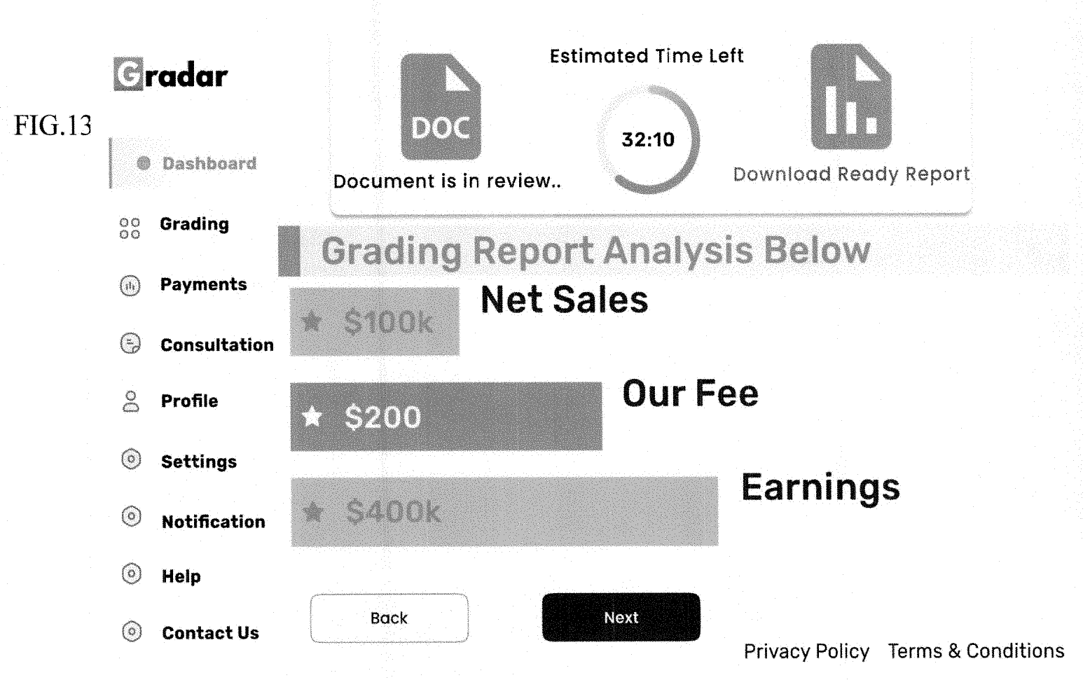

FIG. 14 is another illustration of the UI design and review process of the Gradar system.

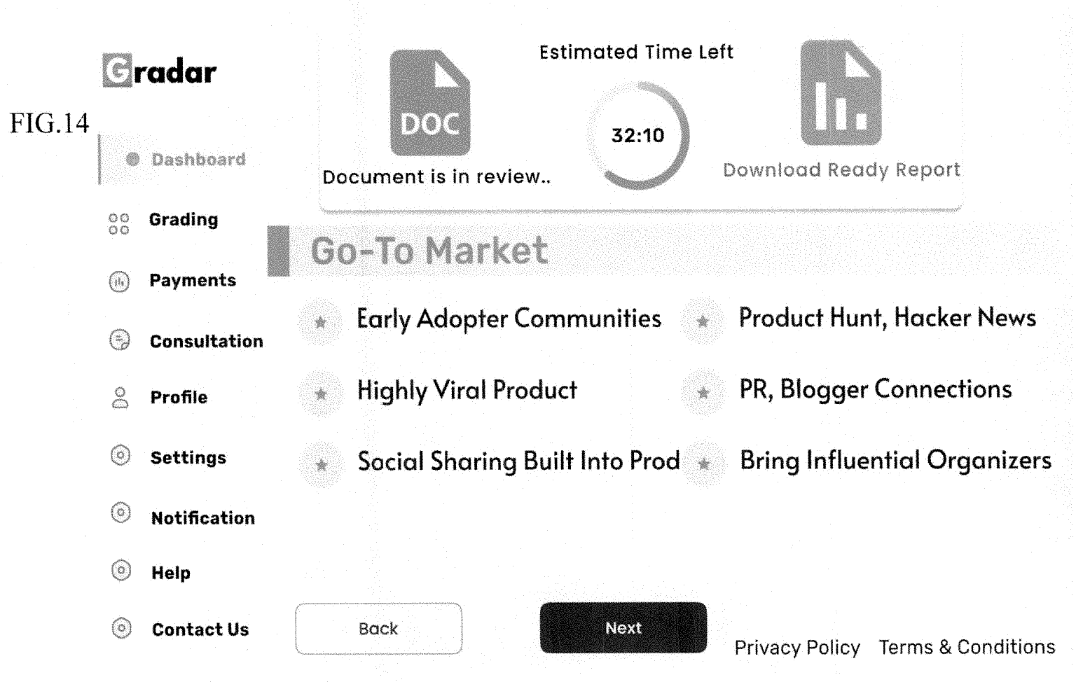

FIG. 15 is another illustration of the user interface when guiding the user through Gradar.

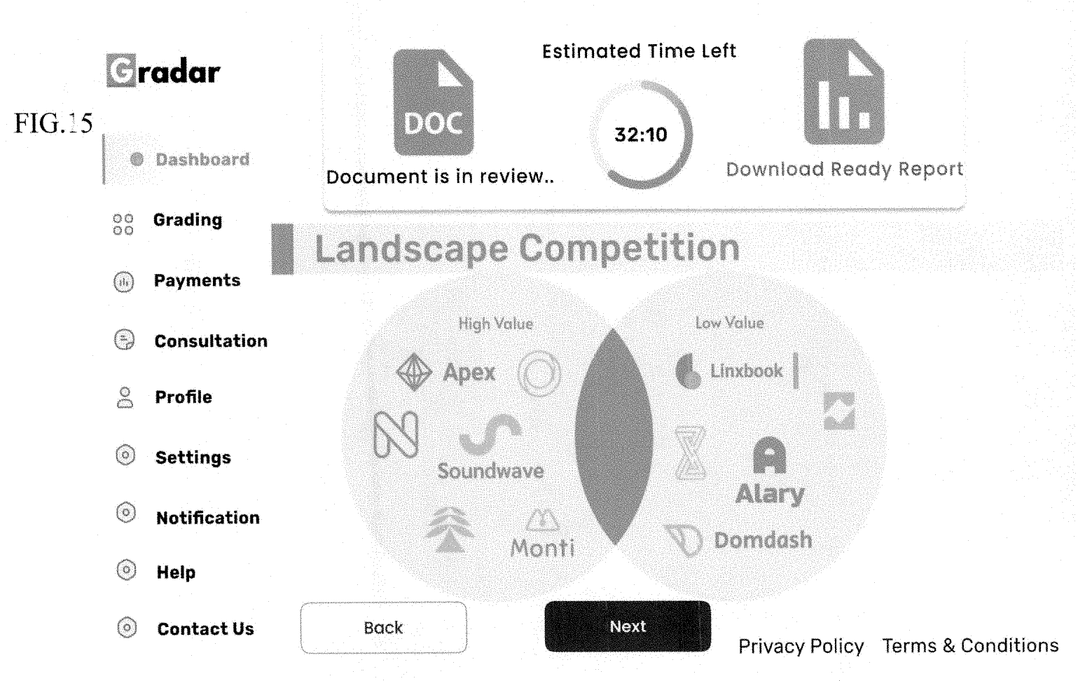

FIG. 16 is another illustration of the Gradar evaluation system.

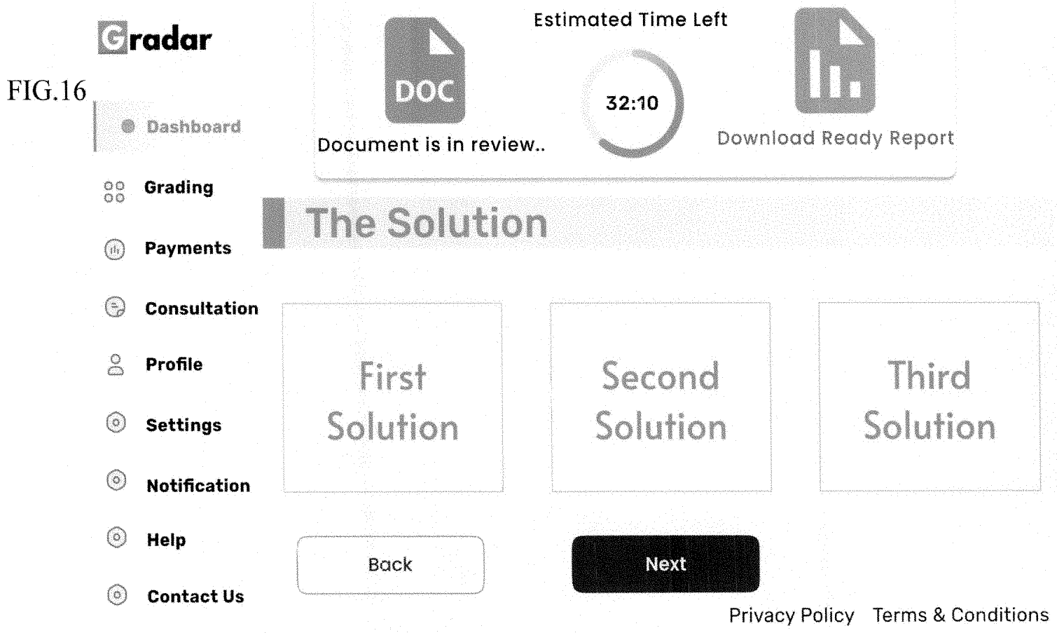

FIG. 17 is another demonstration of the Gradar evaluation and analysis system.

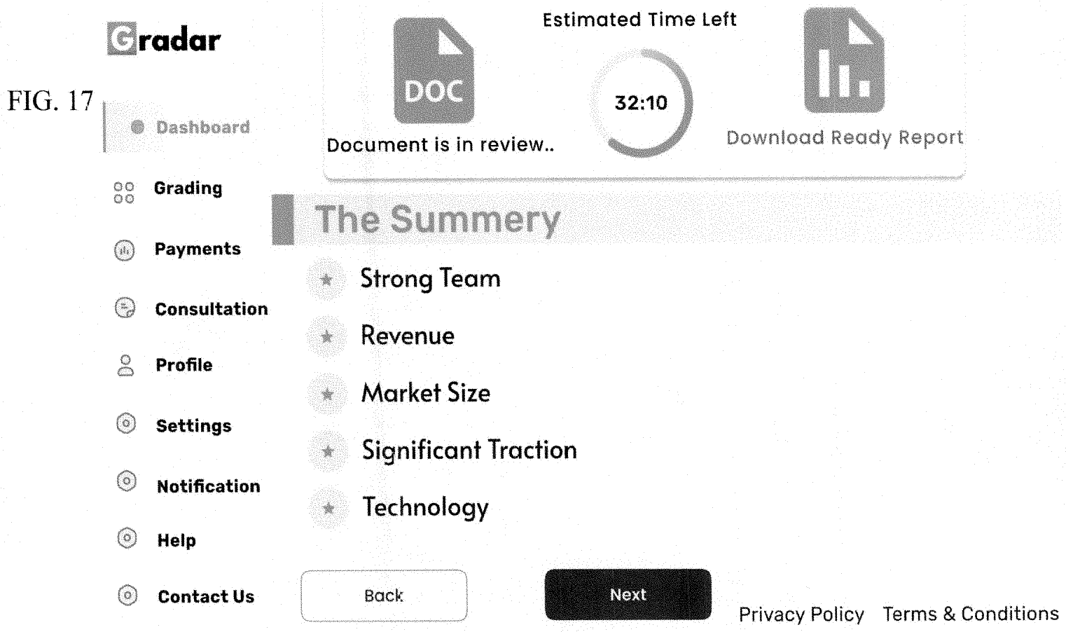

FIG. 18 is the illustration of the Gradar terms and condition terminal for the user to sign up to.

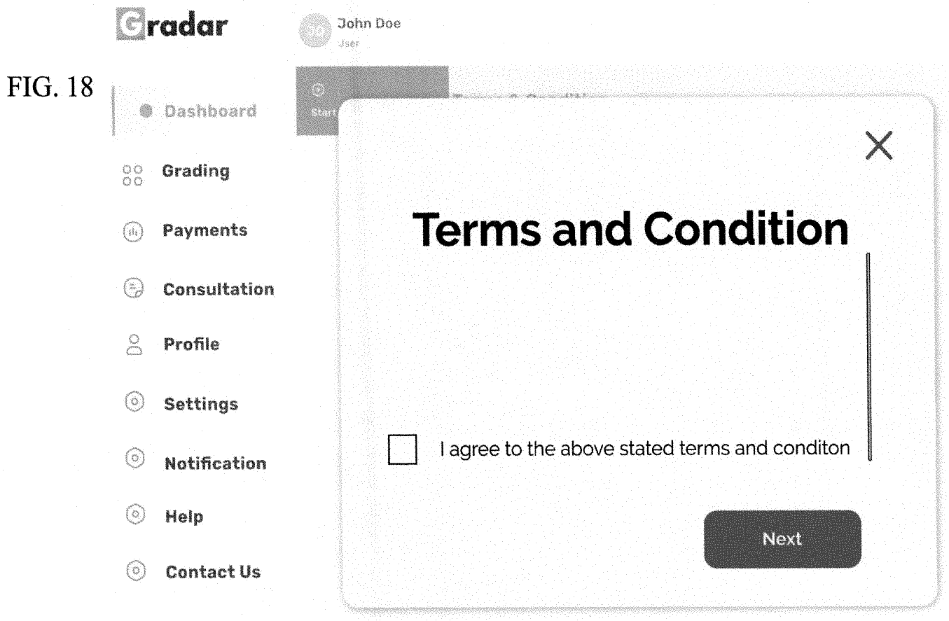

FIG. 19 is the illustration of the Gradar system history related to user activity and their ideas.

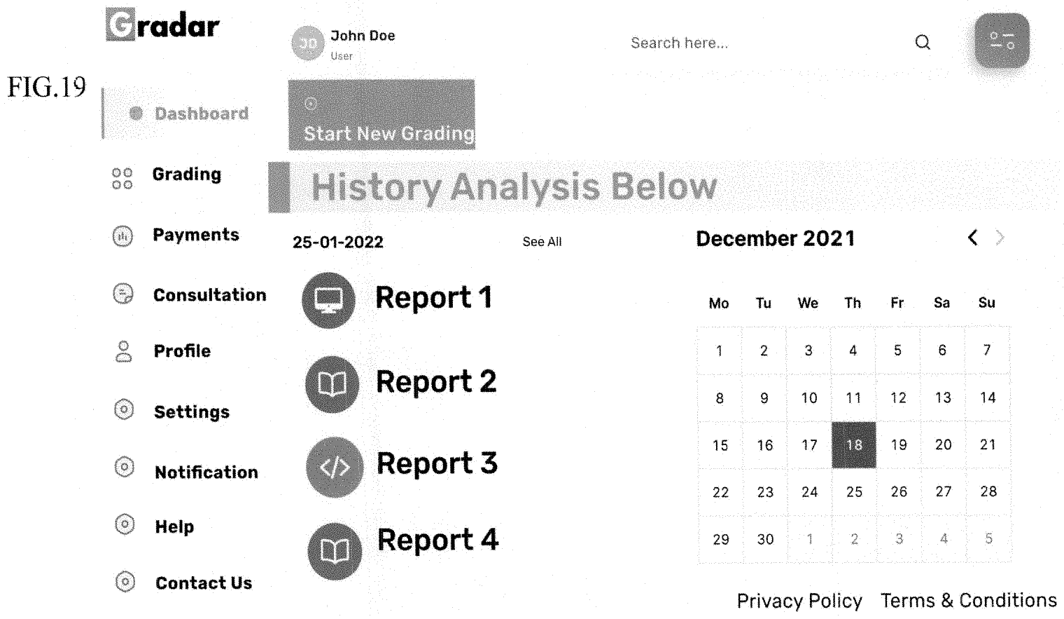

FIG. 20 specifies the User Interface related to notifications of the Gradar system for the user.

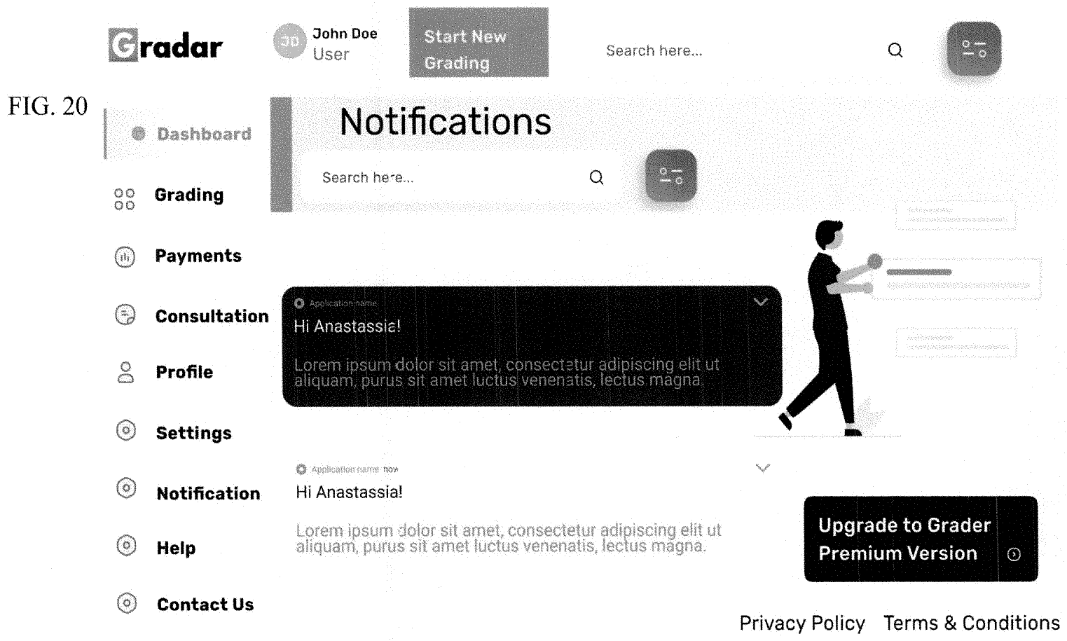

FIG. 21 is the illustration of the banking or payment details or transaction data related to Gradar.

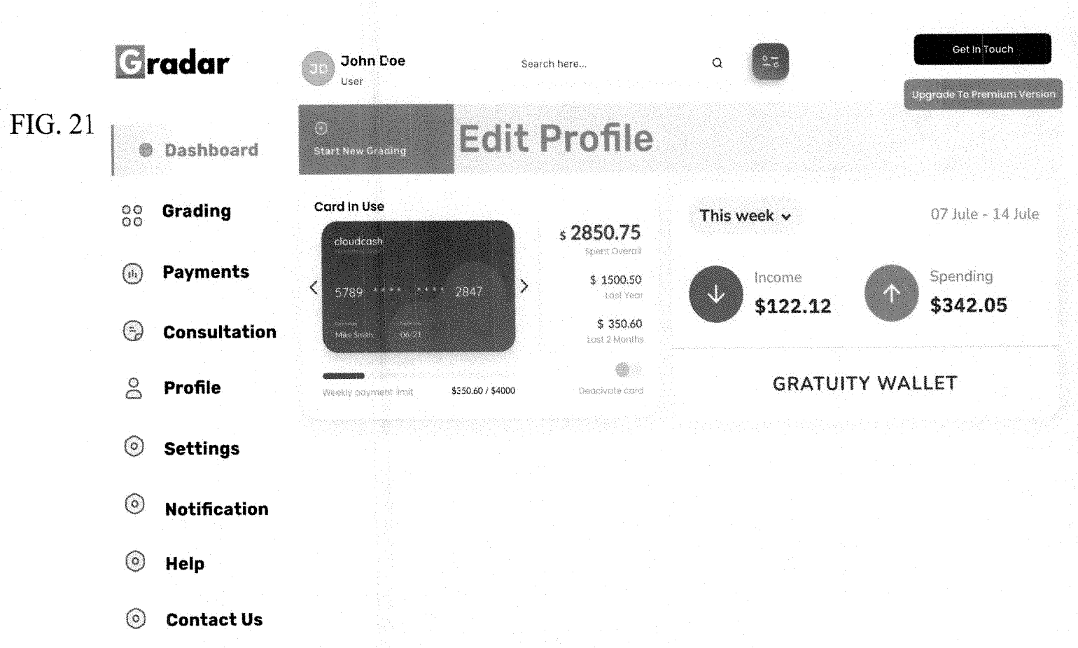

FIG. 22 is the illustration of the user interface of Gradar for booking of appointments for the user.

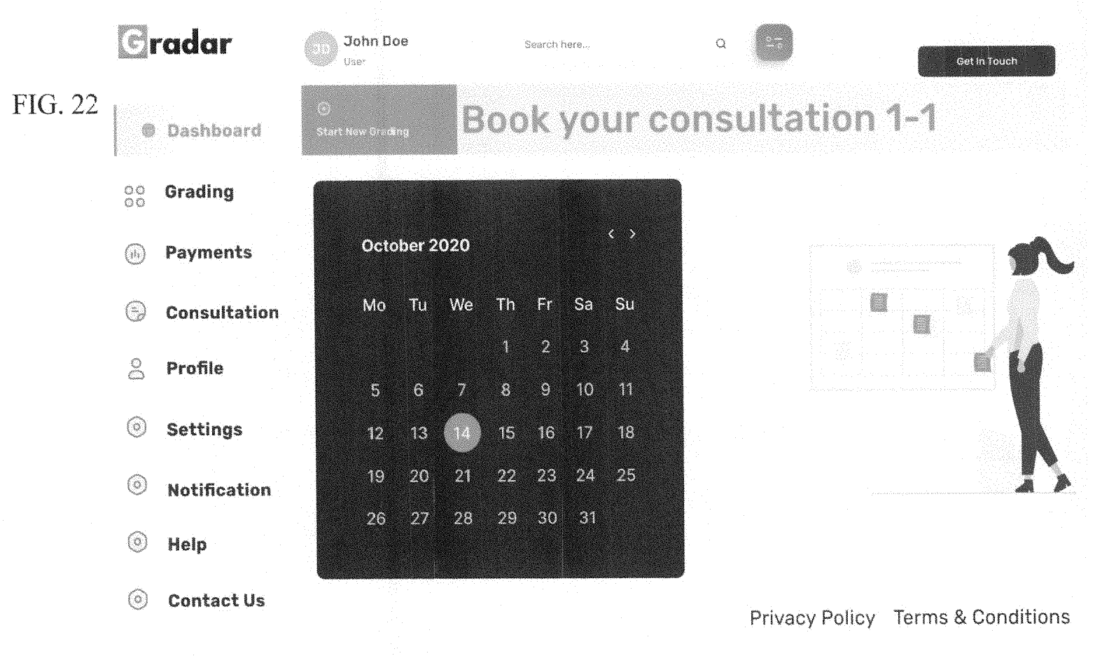

FIG. 23 is the user interface illustration of the users profile set up on the Gradar system.

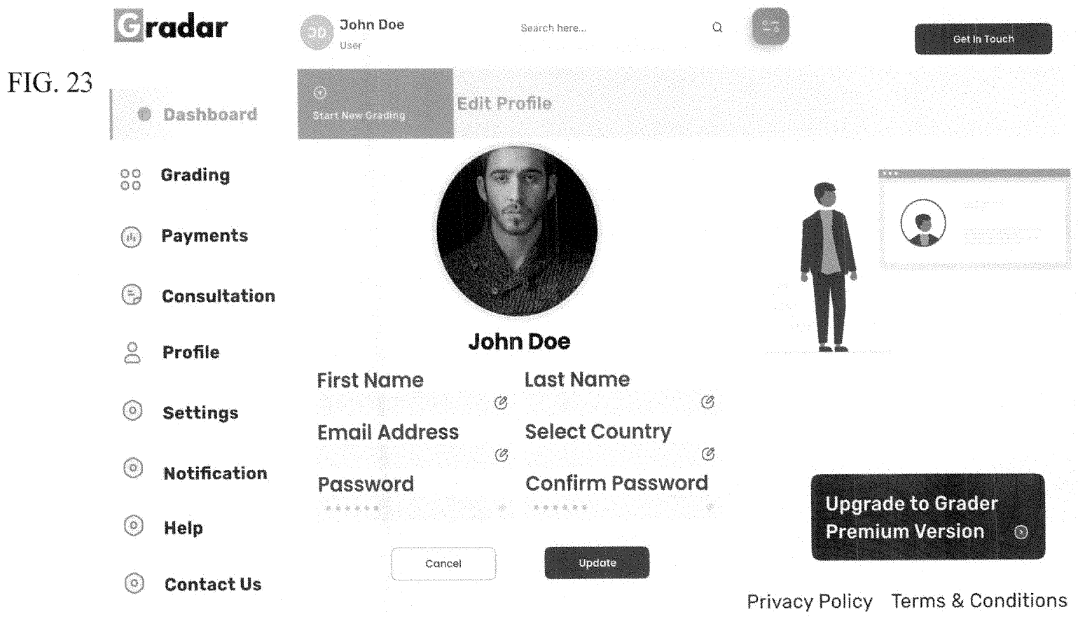

FIG. 24 is the illustration of the user interface of Gradar for booking of appointments for the user.

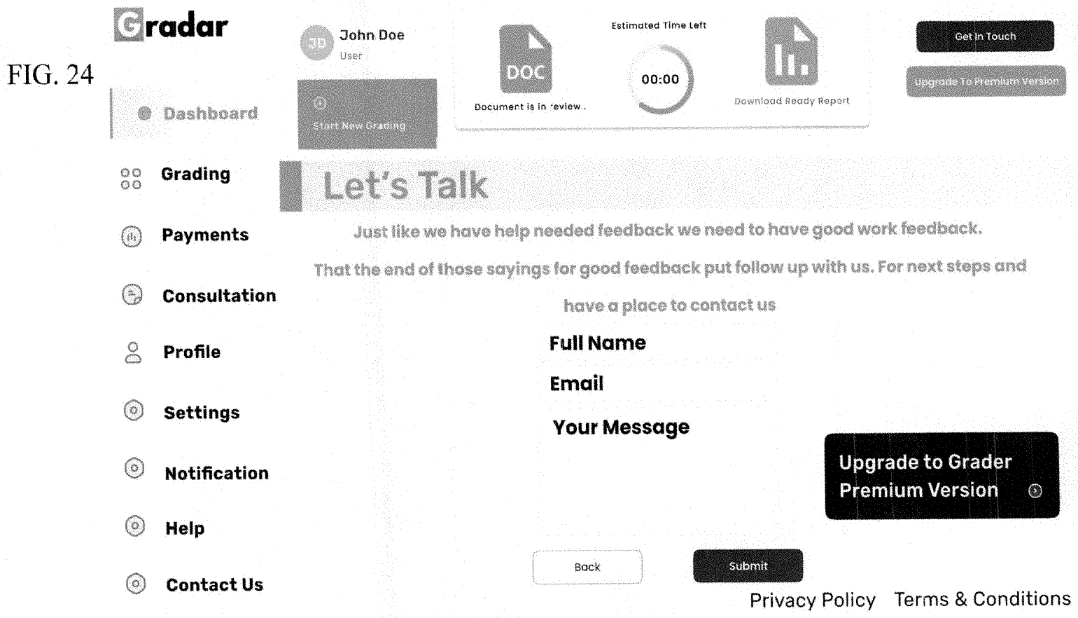

FIG. 25 is the user interface illustration of the contact form for any inquiries or concerns by user.

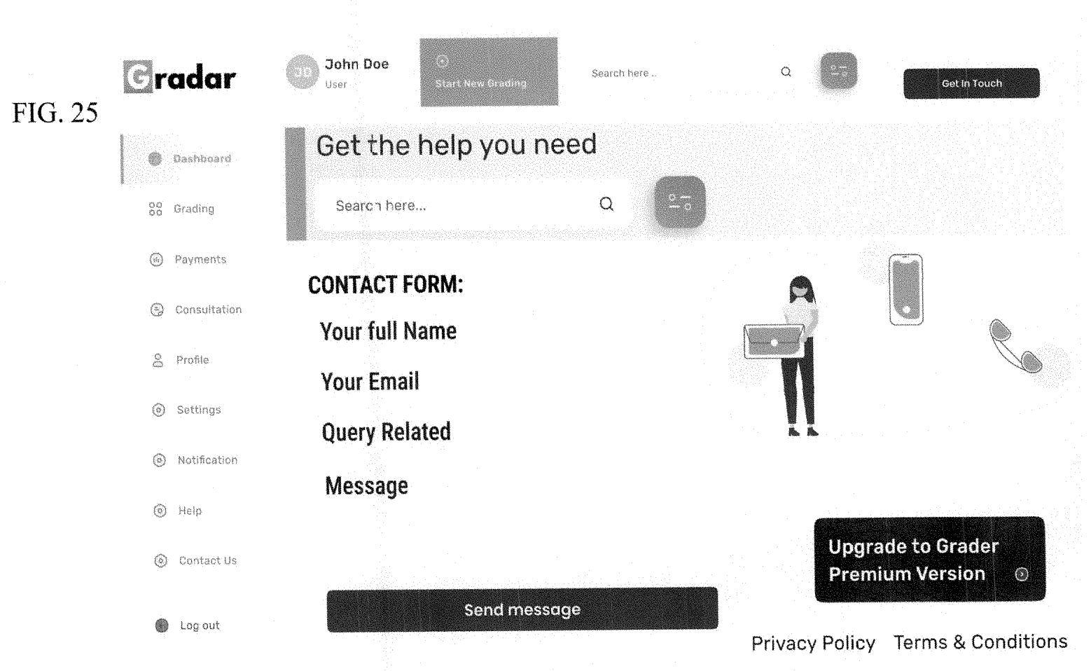

FIG. 26 is an illustration of the conclusion material upon the ending of Pitch Deck Demonstration.

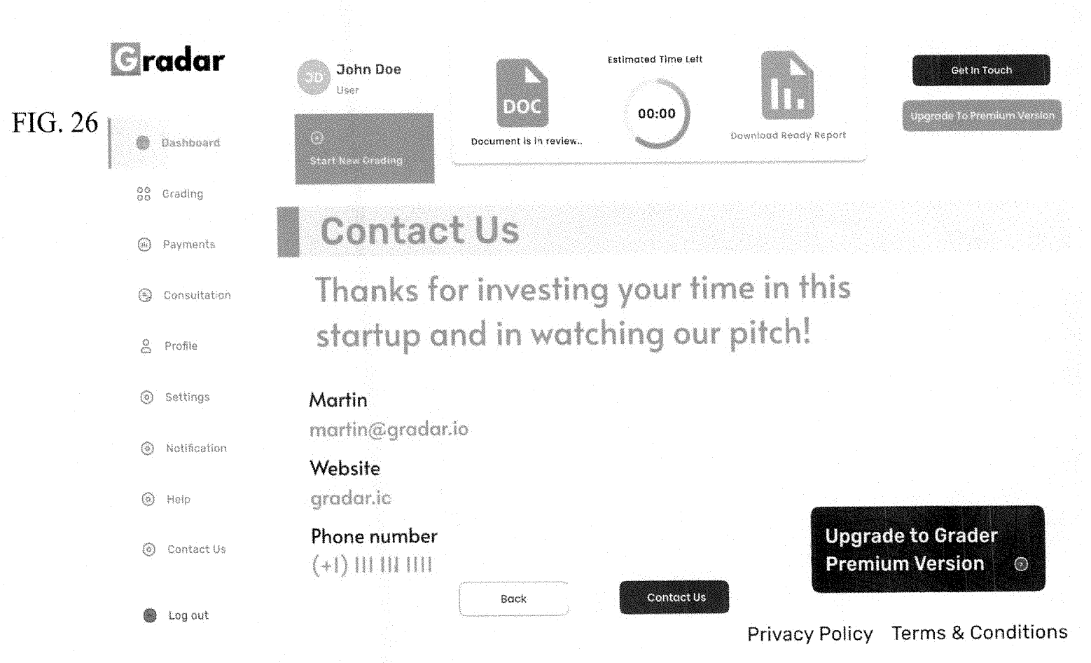

FIG. 27 is the illustration of the Gradar privacy policy rules and regulations.

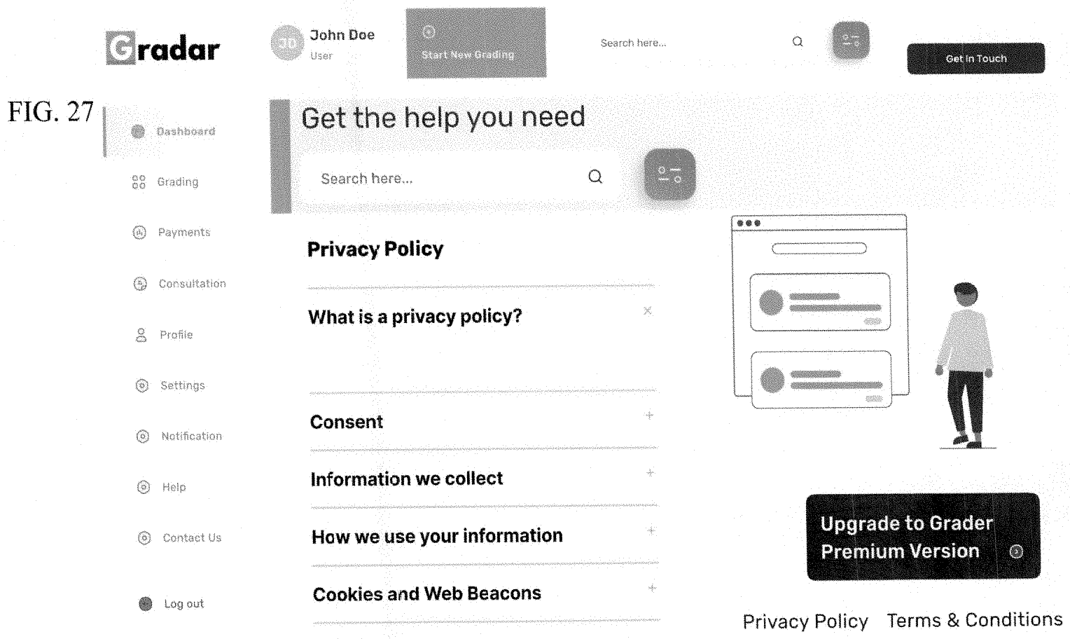

FIG. 28 is the illustration of the Gradar FAO's for the general usage of the user.

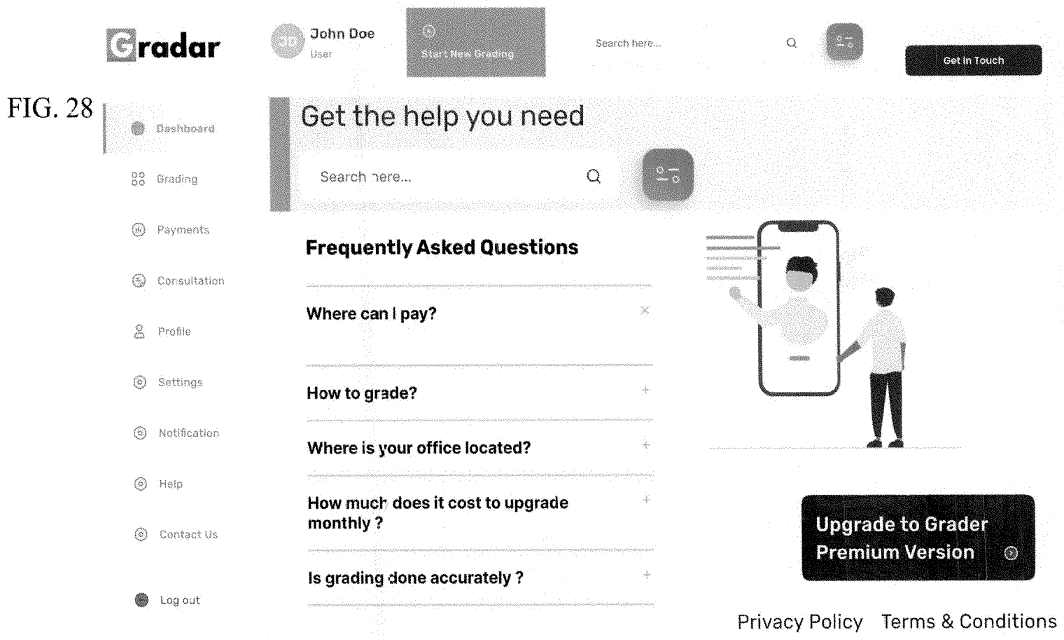

What is claimed is:

1. A Web, Cloud and AI interactive and iterative-implemented system for evaluating and providing feedback on data in slide format or Pitch Deck layout to conduct an analysis on the viability of data or idea in question. Creating an item having associated item data elements;
storing the item data elements in a database; providing real time analysis feedback on the data uploaded via web or app specific usage; choosing an evaluation process for analysis data on the system;

2. The web, cloud and AI-implemented system of claim 1 wherein processing information for the user includes declining the viability based on the results of one or more of monitoring the number of text or information inputted by the user which may not viable from a compliance point of view in raising effect funds. Monitoring data made by the user and providing comments and pointing out errors committed by the user be they grammatical, text volume or over exaggeration of the user's idea, innovation or invention.

3. The web, cloud and AI-implemented system of claim 1 further including the process of a registrar being a web based processor which request and prompts of specific information from the user to be inputted or upload on the platform in question; prompting for payment requests related to the platforms services in support or which correlate with the users evaluation; joint integration and correlation with other system modules and aspects to effectively provide the user with accurate progress of their idea and also incorporated the aspect of booking with experts or mentors to assist the user.

4. The web, cloud and AI-implemented system of claim 1 wherein the Pitch Deck rating module develops a rating for each users Pitch Deck and for each user registered on the platform based on one or more of the amount of the data or analysis for a user, the speed of rating by the system of the users Pitch Deck is based upon the amount of data they have uploaded or provided, as well the amount of errors or issues the system has developed or determined in relation to it.

5. The web, cloud and AI-implemented method of claim 1 implements an inspector cloud based processer which examines each of data of the Pitch Deck or singular slide of the Pitch Deck in detail and provides grading, comments and feedback on each with how to improve and what to alter.

6. The web, cloud and AI-implemented system of claim 1 has implemented a coach system which provides positive feedback for the Pitch Deck slides and lets the user understand in which areas they did well. Following which if after all the feedback and comments relevant corrections are implemented and the Pitch Deck is passed then combine downloadable report is issued which implements the finding of both the inspector and coach suggestions and findings collectively.

7. Further to claim 6 allows the user to then be prompted towards a payment terminal for a consultation with an expert or mentor who will assist the user in securing funding.

8. The web, cloud and AI-implemented system of claim 1 will incorporated a machine learning and AI learning mechanism which will collect data from available information like transcript of shows such as Shark Tank and other similar or related shows and their transcripts to be implemented by the ML and AI systems. These AI and ML systems will then scrape, proofread, convert and create datasets which will be relevant to make sure that the AI and ML has enough to data to effectively analysis ideas, innovation, inventions and provide feedback accordingly.

9. Furtherance to claims 1 and 8, the Registrar also has the capacity to record or input iterative Pitch Deck data as well grade subsequent Pitch Deck slides with a feedback mechanism. For an administrative functionality it also incorporated the ability inform the personal of if the user is opting for a paid service or free one. Additionally, the coach using ML and AI will correct and point out errors related to grammar or punctuation etc. There a Graduation module which along with the Registrar will provide feedback to the user in relation to a rating on the quality of their work or Pitch Deck in association with this.

10. In addition to claims 1 and 8, the Gradar app and web-based platform with the ability for Gradar to auto-generate a custom Pitch Deck with the incorporation of the data being inputted by the user related. It also provides the ability to customize these Pitch Decks in their own unique style similar to an auto generated logo maker such as Wix Logo Maker. It allows Pitch Decks to be template based on the preference of specific area of the business such as Secure-Tech, Fin-Tech, Insure-Tech etc.
